(19) United States
(12) Patent Application Publication
(10) Pub. No.: US 2008/0299265 A1
(43) Pub. Date: Dec. 4, 2008

(54) Fruit Infused Fat Based Table Spread

(76) Inventors: Van Miller, Norval (CA); Vladimir Miller, Thornhill (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 11/756,872

(22) Filed: Jun. 1, 2007

(51) Int. Cl. A23L 1/06

(52) U.S. Cl. 426/102

(57) ABSTRACT

A fat based mixture is used as a spreadable table spread, and is based on an edible oil table spread product which may be table butter, margarine, soft butter, and mixtures thereof. The edible oil table spread product is admixed was 0.5% to 3% by weight of anhydrous freeze-dried fruit, so that the flavor of the admixed fruit infuses the table spread. Typically, the particle size of the admixed freeze-dried fruit is from very fine powder up to 1 mm or 3 mm. Up to 60% by weight of naturally occurring sweetener may also be added,

### FIELD OF THE INVENTION

This invention relates to table spreads, and particularly to spreadable table spreads that are based on butter or margarine, or mixtures thereof, which have freeze-dried fruit admixed thereto. The resulting product is spreadable in the same sense that butter or margarine or spreadable, but it is infused with the flavor of the freeze-dried fruit or fruits that have been admixed into the edible oil table spread.

1. Background of the Invention

The use of jams and jellies on various bread products such as bread, toast, rolls, scones, muffins, bagels, croissants, Danish pastries, and crackers, has been carried on for centuries. Typically, the bread product has first been buttered before the jam or jelly is put into place. By “buttered” it is generally understood that butter, soft butter, or margarine, has been employed. In any event, after the bread product has been buttered and the jam or jelly put into place, a sweet fruit taste, together with the flavor of the bread product itself, is enjoyed when it is consumed.

The edible fat based product which is first placed on the bread product is typically mildly flavored with a salty taste overtone, or it may have just a slightly fatty taste. All such products are referred to as table spreads, but in this case the term is reserved to a reference to butters and margarines. In other words, other animal or vegetable edible oil-based products such as lard, shortening, peanut butter, other nut-based spreads, and the like, are specifically excluded from the present discussion.

The present inventors have quite unexpectedly discovered that if certain freeze-dried fruits are admixed to an edible oil table spread product as described above, then effectively the same taste sensation and the same mouth sense can be achieved as if the bread product has been buttered and then had jam or jelly placed thereon. However, it must be stressed, and will be discussed in greater detail thereafter, that the fruit constituent must have been freeze-dried; and typically the fruit constituent must have a powder-like consistency with particle sizes of typically less than 1 mm, or in any event not greater than 3 mm.

One advantage of freeze-dried fruit is that it is anhydrous, and typically is or can be rendered to have a powder-like consistency. For purposes of present invention, not all fruits are suitable for use as an admixture to edible oil-based table spreads so as to infuse the table spread with fruit flavor. For example, melons of all sorts, apples and pears, avocados, gooseberries, star fruit, pomegranate, and other exotic fruits, are either difficult to freeze dry or have a flavor which is inconsistent with the purposes of the present invention. On the other hand, most berries and currants, and other relatively strongly flavored fruits such as pineapples, or mangoes, peaches, apricots, nectarines, and the like, lend themselves to the purposes of the present invention.

It will be noted that a characteristic of freeze-dried fruit of the sort which are employed herein is that there is typically a high concentration of the fruit flavor present in the freeze-dried product, so that relatively small amounts of freeze-dried fruit will provide the flavor profile that is required. On the other hand, it should also be noted that an additional amount of sweetener, particularly granulated sugar or confectioners' sugar, may be required to achieve the necessary sweetness that is expected of a fruit flavored table spread.

Some brief discussion of the process of freeze drying fruit now follows.

First, it should be noted that freeze-dried fruit is fruit from which the water content has been sublimated. In other words, the freezing step is one which has taken place below the triple point of the fruit which has been freeze-dried, so that it has taken place at a temperature lower than that at which the solid and liquid phases of the fruit can exist. This point may also be referred to as the eutectic point of the fruit. In any event, freeze drying ensures that sublimation rather than melting will have occurred, so that water soluble sugars and flavor elements of the fruit are not carried away from the fruit in a liquid phase.

Typically, freeze drying of fruit is carried out in two phases; a primary drying phase, and a secondary drying phase. These phases are typically carried out under vacuum, and typically at temperatures below −50° C. The primary drying phase may remove as much is 98% of water in the fruit by sublimation; and the secondary drying phase is utilized to sublimate the remaining approximately 2% of water that has been adsorbed during the primary drying phase. Once the fruit has been freeze-dried, the vacuum is usually broken with an inert gas such as nitrogen, and the freeze-dried fruit product may be packaged or further treated for purposes of the present invention.

For example, if the freeze-dried fruit has a large particle size, it may be run through rollers so as to reduce the freeze-dried fruit to a powder. Other processes which are well-known to those skilled in the art may also be employed. Moreover, if fruits such as raspberries or pineapple have been freeze-dried, they may have seeds or fiber chunks which are too large for purposes of present invention. If so, the freeze-dried fruit may be screened so as to remove seeds or other particles which are larger than a given size; typically, 1 mm or 3 mm.

It will be understood, therefore, that the mouth sense of the table spread product in keeping with the present invention, as described hereafter, may range from relatively smooth to slightly grainy.

It should also be noted that if the freeze-dried fruit is packaged in hermetic packaging so as to prevent reabsorption of moisture, it may be stored at room temperature without refrigeration, and be protected against spoilage for several years. This is because essentially all of the water has been removed from the fruit, so as to inhibit the action of microorganisms or enzymes which would normally spoil or degrade the fruit. Moreover, the fruits which are chosen are ones which do not have another liquid constituent which is also capable of sublimation, such as acetic acid or citric acid, or alcohol which might be found in fruit which has begun to ferment.

2. Description of the Prior Art

The present inventors have participated in the preparation of edible fat-based discrete flavoring additives such as those described in U.S. Pat. No. 6,576,287, issued Jun. 10, 2003. That patent, however, is particularly related to the production of anhydrous flavoring additives which are provided in the form of chips, flakes, or chunks, where the edible oil constituent as a melting point of between 20° C. and 40° C., and the flavoring constituent may be such as cinnamon, maple, vanilla, botanical flavors, etc.

### SUMMARY OF THE INVENTION

In accordance with one aspect of the present invention, there is provided a fat-based mixture for use as a spreadable table spread, which comprises as a principal constituent thereof an edible oil table spread product which is chosen from the group consisting of table butter, soft butter, margarine, and mixtures thereof.

The edible oil table spread product is admixed with 0.5% to 3% by weight of anhydrous freeze-dried fruit.

By doing so, the edible oil table spread product is infused with the flavor of the admixed freeze-dried fruit.

Typically, the fruit is chosen from the group consisting of raspberries, strawberries, blueberries, blackberries, loganberries, lingonberries, cranberries, red currants, black currants, mangoes, pineapples, peaches, apricots, nectarines, and mixtures thereof.

In general, the particle size of the admixed freeze-dried fruit is less than 3 mm; and in some cases it may be less than 1 mm.

Because it is a spreadable table spread, a characteristic of the fat-based mixture of the present invention is that it is spreadable at room temperature at least on warm toast; and preferably it may also be spreadable at room temperature on soft bread.

So as to provide additional sweetness to the fat-based edible oil table spread product of the present invention, an additional amount of naturally occurring sweetener which may be chosen from the group consisting of liquid sugar, invert sugar, sucrose, fructose, honey, granulated sugar, finely granulated sugar, or confectioners' sugar, may be added in an amount up to 60% by weight.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

The preparation of the fat-based edible oil spreadable table spreads in keeping with the present invention comprises simply the admixture of freeze-dried fruit to the edible oil-based spreadable table spread; which, as noted, is table butter, soft butter, or margarine. That table spread product may be salted or unsalted, sweetened or unsweetened, entirely butter fat based, entirely vegetable fat based, or mixtures of butter fat and vegetable fat. In other words, the fat-based edible oil spreadable table spread may be considered to be simply off-the-shelf butter, soft butter, or margarine.

The admixture of freeze-dried fruit is a mechanical operation, which may be carried out at room temperature or at a slightly elevated temperature of up to about 40° C. The freeze-dried food constituent may be batch mixed, or continuously mixed, using apparatus and processes which are obvious to those skilled in the butter or margarine arts. However, the freeze-dried fruit may have previously been treated in one manner or in other so as to adjust its consistency to be like a powder, or slightly granular with particle sizes up to 1 mm or even up to 3 mm. This will adjust the mouth sense of the product to some greater or lesser extent; and the chosen particle size may be such as to preclude clogging of mixing nozzles and the like.

Obviously, a mouth sense is desirable that emulates that of butter or margarine having jam or jelly spread thereon, and having been placed on a bread product such as bread, toast, rolls, scones, muffins, bagels, croissants, Danish pastries, crackers, etc. This is accomplished by appropriate adjustment of the SFI characteristics of the butter or margarine or mixture, a matter which is obvious to those skilled in the butter and margarine arts, and which is outside the scope of present invention.

The sweetness of the fat based spreadable table spreads of the present invention is also one which may be of concern. Thus, naturally occurring sweetener which may be chosen from the group consisting of liquid sugar, invert sugar, sucrose, fructose, honey, granulated sugar, finely granulated sugar, confectioners' sugar, or mixtures thereof, may be added to the edible oil-based butter, margarine, or mixtures thereof, in an amount of to 60% by weight thereof. The addition of the sugar may be made at the same time as the freeze-dried fruit constituent is added, or later; but in any event before the edible fat based spreadable table spread is packaged for use either by commercial bakeries, or more particularly for retail consumption.

It should be noted that the additional sweetener, if used, complies with the requirement that it be naturally occurring. In other words, no artificial sweeteners are intended to be used. If the additional sweetener is liquid—such as liquid sugar, invert sugar, sucrose, fructose, or honey—then the water phase of that sweetener will combine with the water phase of the butter or margarine to assure assimilation of the sweetener in the formulation.

However, it must again be stressed that the freeze-dried fruit is such that it has been freeze-dried in a manner whereby the moisture content of the fruit has been sublimated away from the fruit, at a temperature below the triple point or eutectic point of the fruit, whereby an anhydrous product is achieved which has high flavor concentration.

Of course, it will be well understood from the above discussion that the mixtures of butter and/or margarine together with freeze-dried fruit, and optionally with sugar, are mechanical mixtures and are not eutectics.

It will also be understood from the above discussion that the fat based spreadable table spreads of the present invention are capable of being labeled with such wording as “all natural”, because they contain no chemical preservatives or other additives which would require special labeling consideration.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. A fat based mixture for use as a spreadable table spread, comprising as a principal constituent thereof an edible oil table spread product chosen from the group consisting of table butter, soft butter, margarine, and mixtures thereof;
wherein said edible oil table spread product is admixed with 0.5% to 3% by weight of anhydrous freeze-dried fruit;
whereby said edible oil table spread product is infused with the flavor of the admixed freeze-dried fruit.

2. The fat based mixture of claim 1, wherein said fruit is chosen from the group consisting of raspberries, strawberries, blueberries, blackberries, loganberries, lingonberries, cranberries, red currants, black currants, mangoes, pineapples, peaches, apricots, nectarines, and mixtures thereof.

3. The fat based mixture of claim 2, wherein the particle size of the admixed freeze-dried food is less than 3 mm.

4. The fat based mixture of claim 2, wherein the particle size of the admixed freeze-dried food is less than 1 mm.

5. The fat based mixture of claim 2, wherein said edible oil table spread product is spreadable at room temperature on soft bread.

6. The fat based mixture of claim 2, wherein said edible oil table spread product is spreadable at room temperature on warm toast.

7. The fat based mixture of claim 2, further comprising up to an additional 60% by weight of naturally occurring sweetener chosen from the group consisting of liquid sugar, invert sugar, sucrose, fructose, honey, granulated sugar, finely granulated sugar, confectioners' sugar, and mixtures thereof.
